(19) United States
(12) Patent Application Publication
(10) Pub. No.: US 2007/0247458 A1
(43) Pub. Date: Oct. 25, 2007

(54) Adaptive computation of subdivision surfaces

(75) Inventor: Tatiana Surazhsky, Yokneam (IL)

Correspondence Address: Martin D. Moynihan;PRTSI, Inc., P.O. Box 16446, Arlington, VA, 22215, US

(73) Assignee: Samsung Electronics Co., Ltd., Suwon-si (KR)

(21) Appl. No.: 11/783,584

(22) Filed: Apr. 10, 2007

Related U.S. Application Data
(60) Provisional application No. 60/834,811, filed on Aug. 2, 2006.
(60) Provisional application No. 60/790,811, filed on Apr. 11, 2006.

(51) Int. Cl. G06T 17/20; G06T 15/30

(52) U.S. Cl. 345/423

(57) ABSTRACT

A method for the computation of a subdivision surface from a base mesh of coarse faces which requires no dynamic allocations is performed as follows. First, a static data structure is allocated. The static data structure includes a hierarchy of data arrays, where each of the data arrays is for storing control mesh data for a single coarse face at a respective subdivision level. The size of each of the data arrays is determined by the respective subdivision level. A subdivision algorithm is then applied to each of the base mesh coarse faces in turn. During the subdivision of a single coarse face, the resulting data for each subdivision level is stored in the respective data array. The static data structure may store further data for each subdivision level respectively, such as a tag for each of the sub-faces at the given level. The subdivision may be applied adaptively, by applying level-of-detail control information at intermediate subdivision levels.

### RELATED PATENT APPLICATIONS

This application claims the benefit of U.S. Provisional Application No. 60/790,811, filed Apr. 11, 2006, and of U.S. Provisional Application No. 60/834,811, filed Aug. 2, 2006, which are herein incorporated in their entirety by reference.

### FIELD AND BACKGROUND OF THE INVENTION

The present invention relates to adaptive computation of a subdivision surface, and, more particularly, to adaptive subdivision with static data allocations.

Subdivision surfaces are a popular representation used for the geometric modeling of freeform shapes. Amongst the advantages of subdivision representations are their simplicity and their ability to represent shapes of different topologies. For example, the popular Catmull-Clark scheme (Catmull and Clark, 1978, which is incorporated fully herein by reference) recursively subdivides a polygonal mesh. Repeated subdivisions results in smoother meshes, converging to a smooth surface.

The Catmull-Clark scheme is based on the tensor product bicubic spline. It produces surfaces that are C² everywhere, except for the extraordinary vertices (vertices whose valence is not equal to four) where it is C′ (Reif, 1999, which is incorporated fully herein by reference). This scheme is successfully used in animation (DeRose et al., 1998) and game engines such as Half-Life 20 (Valve Corporation, 2004). A survey of subdivision methods is presented in Zorin and Shröder, 2000, which is incorporated fully herein by reference.

While the subdivision process rapidly converges to a visually pleasing smooth surface, rendering all of the polygons of the fine mesh is costly in terms of memory consumption and run time. Moreover, rendering all of these polygons is superfluous, for example if they are not visible or have low curvature.

Adaptive subdivision solves these problems by subdividing only the polygons in problematic areas, such as regions with high curvature or those that are close to silhouette. The concept of adaptive subdivision is closely related to the concept of T-splines (see Sederberg et al., 2004, which is incorporated fully herein by reference), where the control points are inserted only in the regions with more details, unlike the non-uniform, rational B-spline (NURB) case with a regularly structured control mesh.

There are a number of algorithms described in literature that explore the adaptive tessellation problem in the context of subdivision surfaces (Settgast et al., 2004, Havemann, 2002, and Müller and Havemann, 2000, which are incorporated fully herein by reference). Both Settgast et al. (hereinafter Settgast) and Müller and Havemann use a statically allocated data structure of a fixed size to avoid any dynamic allocations.

The Settgast algorithm inputs selected faces of the base mesh into a dedicated process. The process computes the subdivision for the face up to a given depth and renders the result. The subdivision depth passed to the process may vary from face to face, thus producing an adaptively subdivided mesh as the output. Criteria for the subdivision depth parameter include the curvature of the corresponding limit surface patch, its projected size, visibility and silhouette proximity.

Settgast's slate data structure comprises two tables, each of size (2^{k}+3)×(2^{k}+3), where k is the maximal subdivision depth of the mesh, for the subdivision computation, and two sets of one-dimensional arrays of the size 2×valₘₐₓ for the positions of the immediate neighbor vertices (i.e. vertices that share an edge with the corresponding corner vertex), where each set includes four arrays. The subdivision is computed by passing the current level information for the subdivision function in one of the slates and storing the computed result in the second slate. Note that this process destroys the data of the previous subdivision stages and hence each coarse face of the level-zero control mesh is subdivided uniformly. Finer subdivision of restricted areas within the face is not performed even though it may be desired, for example for a surface modeled by the level-of-detail (LOD) modeling approach due to features introduced on a non-zero level of the subdivision, or due to silhouette proximity of a portion of the coarse face.

An additional algorithm is presented by Bolz and Schroder (see J. BOLZ AND P. SCHRÖDER, Rapid Evaluation of Catmull/Clark Subdivision Surfaces, in Proc. of Web3D'02 Symposium, February 2002, pp. 11-17). In this algorithm, a rapid evaluation of subdivision surfaces is performed with the aid of pre-computed tessellations of basis functions for each valence and configuration of special features.

Other works (see J. BOLZ AND P. SCHRÖDER, Evaluation of Subdivision Surfaces on Programmable Graphics Hardware, multires.caltech.edu/pubs/GPUSubD.pdf, and Shiue et al., 2005, which is incorporated fully herein by reference) introduce a GPU-oriented evaluation of subdivision surfaces. These works also employ the local nature of the subdivision schemes to process faces independently.

There is thus a widely recognized need for, and it would be highly advantageous to have, a method and apparatus for adaptive tessellation of subdivision surfaces devoid of the above limitations.

### SUMMARY OF THE INVENTION

According to a first aspect of the present invention there is provided a method for the computation of a subdivision surface from a base mesh of coarse faces. The computation is performed over a plurality of successive subdivision levels, each of the subdivision levels providing a finer mesh of faces, wherein the computation is performed up to a specified maximum of levels. The method includes the steps of: allocating memory for a static data structure comprising a hierarchy of data arrays, wherein each of the data arrays is for storing control mesh data for a single coarse face at a respective subdivision level, and wherein a size of each of the data arrays is determined by the respective subdivision level; subdividing a coarse face defined by the base mesh; and storing data resulting from each subdivision level in the respective data array.

Preferably the method includes the further step of performing the computation adaptively, by, at each subdivision level prior to the specified maximum of levels, separately determining whether to perform a further level of subdivision for each sub-face at the subdivision level.

Preferably, the subdividing is performed sequentially for each of the coarse faces.

Preferably, the subdividing is performed recursively.

Preferably, the subdivision surface comprises a mesh of polygons.

Preferably, the subdividing a face includes the steps of determining whether a further level of subdivision of the face is required, and, if a further level is required, subdividing the face into a plurality of sub-faces.

Preferably the method includes the further step of providing the plurality of sub-faces as input for a subsequent level of subdividing.

Preferably, the determining is performed in accordance with at least one of a group of characteristics of the face, the group comprising: visibility, projected size, presence of special features, silhouette, and curvature.

Preferably, the data arrays are for storing two-dimensional data.

Preferably, for a subdivision level, the data stored in the respective data array comprises a respective position of all vertices of the sub-faces of the coarse face at the subdivision level, and a respective position of all vertices comprising immediate neighbors of the vertices of the sub-faces of the coarse face at the subdivision level.

Preferably, a size of the respective data array for a specified subdivision level comprises a minimal size for storing coordinates for a fully-divided coarse face at the specified subdivision level.

Preferably, a size of the respective data array for a specified subdivision level comprises (2k+3)², wherein k equals the specified subdivision level.

Preferably, the static data structure further comprises a respective pseudo-face data array for each of the subdivision levels, the pseudo-face data array being for storing a respective tag for controlling a subsequent level of subdividing, for each sub-face of the coarse face.

Preferably, the static data structure further comprises a respective neighboring vertex array for each corner vertex of the coarse face, a neighboring vertex array being for storing positions of immediate neighbor vertices of the respective corner vertex.

Preferably, the static data structure further comprises a respective opposing vertex array for each corner vertex of the coarse face, an opposing vertex array being for storing positions of opposing vertices of neighboring faces of the respective corner vertex.

Preferably the method includes the further step of calculating a respective edge subdivision depth for each edge of the coarse faces of the base mesh, wherein the edge subdivision depths are for controlling the subdividing.

Preferably the method includes the further step of ensuring that a difference in subdivision depths of adjacent coarse faces of the subdivided surface is bounded to a specified maximum difference.

Preferably the method includes the further step of preprocessing an original mesh for subdivision to form a base mesh appropriate for the subdividing.

Preferably the method includes the further step of tessellating the subdivided surface.

Preferably, the tessellating comprises removing T-junctions from the subdivided surface.

Preferably, tessellating an edge shared by adjacent coarse faces of the base mesh is performed in accordance with edge subdivision depths calculated respectively for each of the adjacent coarse faces.

Preferably, tessellating an edge shared by adjacent sub-faces within a coarse face is performed in accordance with tags stored in a pseudo-face data array.

Preferably the method includes the further step of rendering the subdivided surface for display.

Preferably, the subdividing comprises the steps of: for each of the faces, calculating a face control point as an average of the corner of vertices of the face, and initializing a respective data array of a subsequent level of subdivision with the computed face control points.

Preferably, the subdividing includes the further steps of: calculating even control points for the subsequent level of subdivision from even control points of a current level of subdivision, edge control points of the current level of subdivision and face control points of the subsequent level of subdivision, calculating edge control points as an average of the edge endpoints of the faces and of the computed face control points for faces adjacent to the face, and further initializing the respective data array of the subsequent level of subdivision with the computed edge control points and the computed even control points.

According to a second aspect of the present invention there is provided an apparatus for the computation of a subdivision surface from a base mesh of coarse faces. The computation is performed over a plurality of successive subdivision levels, each of the subdivision levels providing a finer mesh of faces, wherein the computation is performed up to a specified maximum of levels. The apparatus includes a data structure allocator and a surface subdivider. The data structure allocator is configured for allocating a static data structure comprising a hierarchy of data arrays, wherein each of the data arrays is for storing control mesh data for a single coarse face at a respective subdivision level, and wherein a size of each of the data arrays is determined by the respective subdivision level. The surface subdivider is configured for subdividing a coarse face defined by the base mesh, and for storing data resulting from each subdivision level in the respective data array.

Preferably, the surface subdivider is operable to perform the computation adaptively by, at each subdivision level prior to the specified maximum of levels, separately determining whether to perform a further level of subdivision for each sub-face at the subdivision level.

Preferably, the data structure allocator is operable to allocate the static data structure prior to the performance of the subdividing.

Preferably, the surface subdivider is further configured to ensure that a subdivision level is within the specified maximum of levels.

Preferably, the surface subdivider is further configured to subdivide each coarse face of the base mesh separately from other coarse faces of the base mesh.

Preferably, for a subdivision level, the data stored in the respective data array comprises a respective position of all vertices of the sub-faces of the coarse face at the subdivision level, and a respective position of all vertices comprising immediate neighbors of the vertices of the sub-faces of the coarse face at the subdivision level.

Preferably, a size of the respective data array for a specified subdivision level comprises (2k+3)², wherein k equals the specified subdivision level.

Preferably, the static data structure further comprises a respective pseudo-face data array for each of the subdivision levels, the pseudo-face data array being for storing a respective tag for controlling a subsequent level of subdividing, for each sub-face of the coarse face.

Preferably, the static data structure further comprises a respective neighboring vertex array for each corner vertex of the coarse face, a neighboring vertex array being for storing positions of immediate neighbor vertices of the respective corner vertex.

Preferably, the static data structure further comprises a respective opposing vertex array for each corner vertex of the coarse face, an opposing vertex array being for storing positions of opposing vertices of neighboring faces of the respective corner vertex.

Preferably, the surface subdivider comprises a face level determiner configured for determining whether a further level of subdivision of the face is required.

Preferably, the surface subdivider comprises an edge level determiner configured for calculating a respective subdivision depth for each edge of the coarse faces of the base mesh, wherein the edge subdivision depths are for controlling the subdividing.

Preferably, the surface subdivider is configured for ensuring that a difference in subdivision depths of adjacent faces of the subdivided surface is bounded to a specified maximum difference.

Preferably, the apparatus further includes a preprocessor configured for preprocessing an original mesh for subdivision to form a base mesh appropriate for the subdividing.

Preferably, the apparatus further includes a renderer configured for tessellating the subdivided surface.

Preferably, tessellating comprises removing T-junctions from the subdivided surface.

Preferably, the renderer is further configured for rendering the subdivided surface for display.

Preferably, the apparatus further includes a user interface configured for interactively obtaining user control information during the subdividing.

According to a third aspect of the present invention there is provided a computer-readable storage medium containing a set of instructions for a method for calculating a subdivision surface. The set of instructions includes: a data structure allocation routine and a subdivision routine. The data structure allocation routine allocates memory for a static data structure comprising a hierarchy of data arrays, wherein each of the data arrays is for storing control mesh data for a single coarse face at a respective subdivision level, and wherein a size of each of the data arrays is determined by the respective subdivision level. The subdivision routine subdivides a coarse face defined by the base mesh, and stores data resulting from each subdivision level in the respective data array.

According to a fourth aspect of the present invention there is provided a method for rendering a subdivision surface derived from a base mesh of coarse faces. The method includes the steps of: calculating a respective edge subdivision depth for each edge of the coarse faces, and tessellating a subdivision surface defined in a data structure comprising a hierarchy of data arrays, wherein each of the data arrays is for storing control mesh data for a coarse face at a respective subdivision level, in accordance with the calculated subdivision depths so as to eliminate T-junctions along the edges.

The present invention successfully addresses the shortcomings of the presently known configurations by providing an adaptive subdivision scheme with a static data structure.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a-1e show several subdivision control meshes of a surface modeled using the level-of-detail (LOD) approach;

FIG. 2 is a simplified flowchart of a method for computing a subdivision surface patch corresponding to a single coarse face, according to a preferred embodiment of the present invention;

FIG. 3 is a simplified flowchart of an overview of the subdivision and rendering process, according to a preferred embodiment of the present invention;

FIG. 4 is a simplified flowchart of method for subdividing a face of a surface, according to a preferred embodiment of the present invention;

FIG. 5 is a simplified flowchart of an exemplary main oracle function;

FIGS. 6a-6c illustrate an example of the initialization of level-zero and level-one data structures for an illustrated face of a base mesh;

FIGS. 7a and 7b show an example of input data for the main and edge oracles respectively;

FIG. 8 shows a mesh with T-junction topology;

FIG. 9 is a simplified flowchart of a method for tessellating a quad mesh, according to a preferred embodiment of the present invention;

FIG. 10 illustrates a tessellated version of the mesh of FIG. 8;

FIG. 11 is a simplified block diagram of an apparatus for computing a subdivision surface, according to a preferred embodiment of the present invention;

FIG. 12 is a simplified block diagram of a method for rendering a subdivision surface derived from a base mesh of coarse faces, according to a preferred embodiment of the present invention;

FIG. 13a shows an exemplary base mesh;

FIG. 13b shows a mesh formed by adaptively-subdividing the base mesh of FIG. 13a;

FIG. 13c shows a mesh formed by adaptively-subdividing the base mesh of FIG. 13a with one of the faces of the base mesh deleted.

### DESCRIPTION OF THE PREFERRED EMBODIMENTS

The present embodiments are of a scheme for the adaptive computation of subdivision surfaces, which may be used, for example, for rendering dynamic scenes and interactive rendering of animated character models. Specifically, the present embodiments introduce an adaptive subdivision scheme which requires no modifications of the coarse control mesh, with reduced memory consumption and with no dynamic allocations. The subdivision surface may be rendered with no modifications of the control mesh, while allowing flexible tessellation on all subdivision levels as well as feature support (e.g. sharp edges and boundaries) for each level.

In the present embodiments, the subdivision process repeatedly refines a mesh of vertices, edges and faces, and finally converges to a smooth limit surface. At each step the positions of the finer mesh are preferably computed as weighted averages of the positions in the previous coarser level mesh. Sharp edges and features may be introduced on any subdivision level, which is a useful feature for subdivision modeling. This LOD approach is natural for the artist, and reduces the storage space required for the final model. It is not necessary to input the whole fine mesh, only the coarse base mesh and the introduced modifications are required for the reconstruction of the surface.

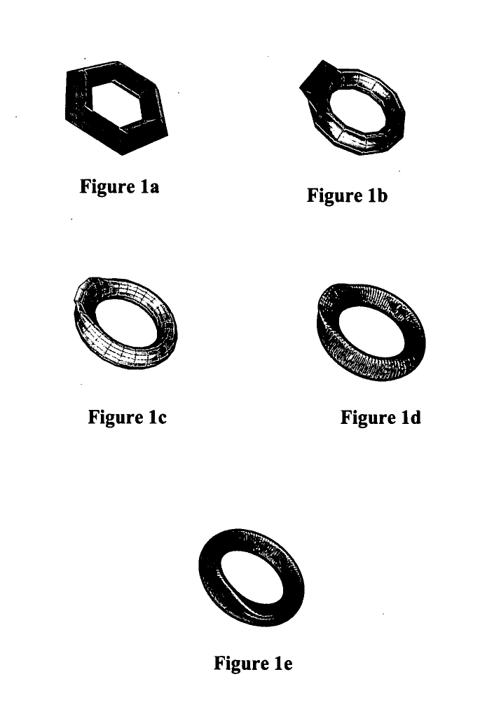

Reference is now made to FIGS. 1a-1e, which illustrate a subdivision of a base mesh, modeled using the LOD approach. The process begins with the base mesh (also denoted herein the level-zero mesh) of FIG. 1a and the offsets for the two level-one vertices. Further levels of subdivision are shown in FIGS. 1b-1e. It is seen that the subdivision process converges to a smooth surface.

The principles and operation of a scheme for adaptive formation of subdivision surfaces according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The present embodiments are based on a subdivision and rendering process in which each coarse face (i.e. face of the base mesh) is passed to a subdivision function that allocates a static data structure prior to initiating the subdivision of the base mesh coarse faces. The static data structure is suitable for storing all the geometric data resulting from the subdivision of a single face. The output of the function is a set of rendered polygons that describe a smooth patch corresponding to the input coarse face.

In the preferred embodiment, the static data structure maintains a hierarchy of data arrays for the geometry computations. The data arrays are of varying size, according to the requirements of each subdivision level. Thus the smallest array is used for the level-zero data array (which includes the smallest number of faces) and the largest array is used at the maximum subdivision depth. In the preferred embodiment, for each subdivision level k=0, . . . , maxₗₑᵥₑₗ there is a array of the size (2^{k}+3)×(2^{k}+3) that stores the geometry of the control mesh on the corresponding level.

Note that space complexity of this data structure does not exceed that of Settgast, who uses two arrays for storing geometrical data, each sized for the maximal resolution of k=maxₗₑᵥₑₗ. Mathematically this may be expressed as:

$${\sum }_{k = 0}^{{k}_{max}} {( {2}^{k} + 3 )}^{2} < 2 \cdot {( {2}^{k} + 3 )}^{2} , for {k}_{max} > 0.$$

For example, for kₘₐₓ=4 we have that

$${\sum }_{k = 0}^{4} {( {2}^{k} + 3 )}^{2} = 572 ,$$

while 2·(2^{k}+3)²=722.

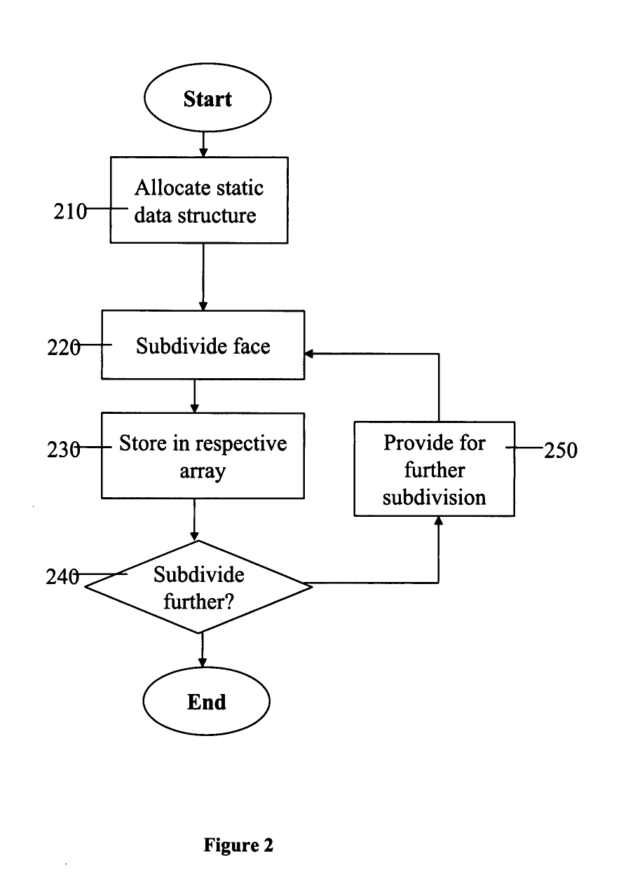

Reference is now made to FIG. 2, which is a simplified flowchart of a method for computing a subdivision surface patch corresponding to a single coarse face of a base mesh, according to a preferred embodiment of the present invention. The base mesh describes an initial subdivision of a surface into relatively large faces (preferably polygons). The computation is performed over multiple successive subdivision levels, which provide successively finer control meshes. In step 210 a static data structure is allocated. The static data structure includes a hierarchy of data arrays, where each data array stores the control mesh data for a respective subdivision level. The size of each data array is determined by the respective subdivision level.

In step 220, a coarse face defined in the base mesh is subdivided. In step 230, the data resulting from the previous subdivision level is stored in the respective data array. In step 240, a determination is made whether further subdivision is required. The subdivision process may proceed up to a specified maximum number of levels (also denoted the maximum subdivision depth maxₗₑᵥₑₗ). In the preferred embodiment, the subdivision process is adaptive. A determination is made for each sub-face at the current subdivision level whether to perform a further level of subdivision for that sub-face, as described in detail below. As a result, the coarse face may be subdivided in a non-uniform manner, leading to increased computational efficiency. The subdivision process is preferably performed in turn on each face defined by the base mesh data. In step 250, sub-faces which were determined to require another subdivision level are provided for further subdivision.

The contents of the data stored in the static data structure are determined by the specific subdivision process performed in step 230. The non-limiting embodiments below are directed at a Catmull-Clark subdivision scheme, although the method is not restricted to a particular subdivision scheme and the extension to other schemes is straightforward. The same approach may be adapted to any local subdivision scheme, such as Doo-Sabin, Loop, Kobbelt, Butterfly, etc. (for a review of subdivision techniques see Zorin and Shröder, 2000, which is incorporated fully herein by reference).

The data array for each subdivision level stores the positions of the control vertices for that subdivision level. The control vertices include all vertices of the currently subdivided face and their immediate neighbor vertices. The data array is preferably structured for storing two-dimensional data. Any suitable structure may be used, including a one-dimensional array, a two-dimensional array, a linked list, etc . . .

In a first preferred embodiment, the size of each data array is the minimal size necessary for storing the coordinates (i.e. control points) for a fully-divided coarse face at the respective subdivision level. In a second preferred embodiment, the data array size is (2^{k}+3)×(2^{k}+3) for each of levels k=0, . . . , maxₗₑᵥₑₗ.

Preferably, the subdivision process is performed recursively. At each level of subdivision the current face is divided into multiple sub-faces. These sub-faces serve as the input to the next level of subdivision. In the following the subdivision process is described for a face of the surface, however the face currently undergoing subdivision may in actuality be a sub-face of a previous level of the subdivision process.

In addition, the static data structure preferably further includes a pseudo-face data table for each of the subdivision levels. The pseudo-face tables store control data for performing the subdivision, thus enabling fine control of the subdivision depth for different regions within each face. The pseudo-face data provides useful information for closing the gaps between the differently subdivided faces, as described below.

The pseudo-face tables preferably store a tag for each face (or sub-face) at the current subdivision level. The tag may include information regarding one or more of:
The face is active (Boolean value)-Indicates that the face is initialized and that the face control points are computed and written to the table.
The face is subdivided (Boolean value)-Indicates that the subsequent level faces are initialized.
Edge/vertex indicators—Allow special treatment of edge and vertex information (e.g. the edge/vertex is sharp/semi-sharp/boundary). The number of required indicators per edge/vertex is determined by the nature of the data required by the subdivision algorithm.

As discussed above, in the preferred embodiment, the subdivision process is performed adaptively, by determining after each level of subdivision whether a subsequent level of subdivision is required for each sub-face, up to the specified maximum subdivision depth maxₗₑᵥₑₗ. If further subdivision is required, the sub-face is itself subdivided. The determination whether or not the sub-face should be subdivided further is preferably performed by the main and edge oracle functions discussed below. Further input may be provided interactively by the artist. LOD modeling may thus be easily incorporated into the subdivision process.

The static data structure for each subdivision level also includes a neighboring vertex array and/or an opposing vertex array for each corner vertex of the currently subdivided face. The neighboring vertex array is used to store the positions of immediate neighbor vertices of the corner vertex. The opposing vertex array is used to store the positions of opposing vertices of faces neighboring the corner vertex.

A pre-processing stage may be performed if the original mesh provided for subdivision is not in a suitable form for the subdivision scheme used. The pre-processing stage modifies the original mesh into a base mesh appropriate for subdivision.

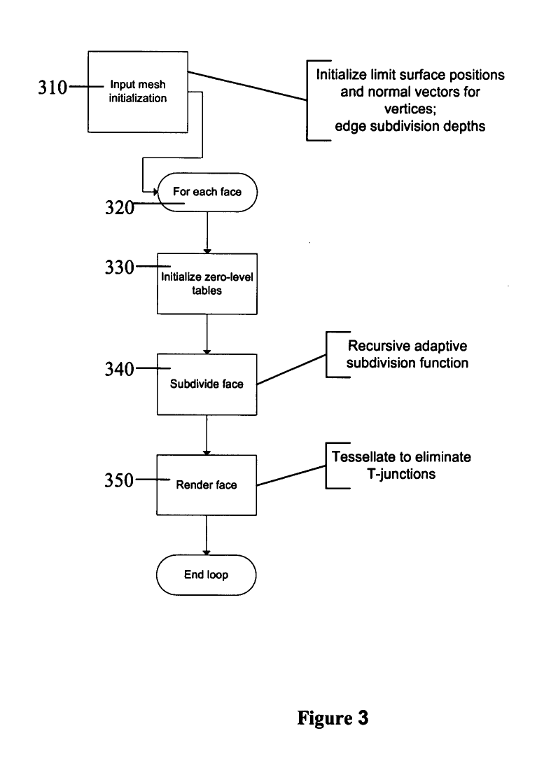

Reference is now made to FIG. 3, which is a simplified flowchart of an overview of the subdivision and rendering process, according to a preferred embodiment of the present invention. First we compute limit positions and normal vectors for the coarse base mesh vertices, and edge subdivision depths (step 310). Then each face is subdivided adaptively (steps 330 and 340) and rendered (step 350).

The preferred embodiment described below is defined for meshes with quadrilateral faces, but is extendable to general meshes as well. The rules for subdivision are summarized as follows:
1) A face control point f^{j+1} is computed as the average of its corner vertices:

$${f}^{j + 1} = \frac{1}{n} {\sum }_{i = 0}^{n} {v}_{i}^{j} ;$$

2) An edge control point e^{j+1} is the average of the edge endpoints and the newly computed face control points of the adjacent faces:

$${ⅇ}^{j + 1} = \frac{{v}_{1}^{j} + {v}_{2}^{j} + {f}_{1}^{j + 1} + {f}_{2}^{j + 1}}{4} ;$$

3) Even control points (i.e. control points corresponding to the previous level control points) are computed as:

$${v}^{j + 1} = \frac{m - 2}{m} {v}^{j} + \frac{1}{{m}^{2}} {\sum }_{i = 0}^{m - 1} {ⅇ}_{i}^{j} + \frac{1}{{m}^{2}} {\sum }_{i = 0}^{m - 1} {f}_{i}^{j + 1} ,$$

where m is the valence of the vertex (where the valence equals the number of edges incident to the vertex) and n is the number of vertices in the corresponding face.

Vertices on the boundaries or creases are computed using different rules that use coefficients for the cubic splines, see for example DeRose et al., 1998.

The subdivision process defines a smooth limit surface, which locally has a closed form and can be evaluated (see Biermann et al., 2000, and Stam, 1998, which are incorporated fully herein by reference, for the evaluation of the positions and normal vectors of the limit surface at the vertices of the control mesh).

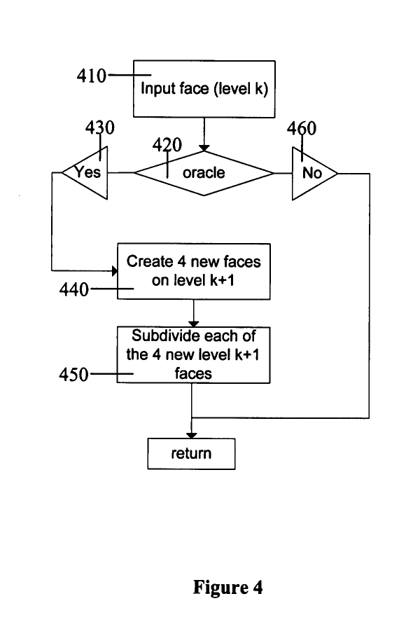

Reference is now made to FIG. 4, which is a simplified flowchart of method for subdividing a face of a surface, according to a preferred embodiment of the present invention. The method of FIG. 4 is based on a main oracle function which regulates the subdivision depth for each face (at each level of the subdivision process). The main oracle function analyzes data such as the presence of features within the face, silhouette, and visibility, and returns a Yes/No answer regarding whether the current face should be subdivided. The data used by the main oracle function may be obtained from the pseudo-face data tables and/or may be externally provided for example by the artist. Additionally, an edge oracle function is used to constrain the subdivision depth along the edges of the base mesh.

In step 410 the data for a selected face is provided. The face data is obtained from the respective data array (and possibly the respective pseudo-face data table and/or other data sources) for the current subdivision level. That is, the data for subdividing a face from the base level mesh is taken from the level-zero data array, while the data for subdividing a face obtained after the first subdivision iteration is taken from the level-one data array.

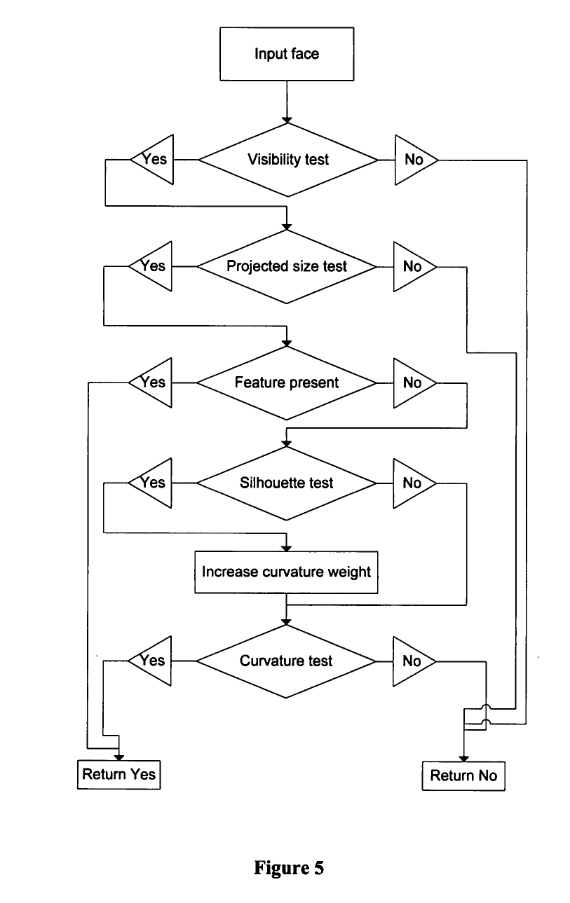

The main oracle function analyzes the face data and determines whether a further subdivision iteration should be performed (step 420). A simplified flowchart of an exemplary main oracle function which includes considerations of visibility, projected size, features, silhouette, and curvature is shown in FIG. 5. If the main oracle function returns “Yes” (step 430), then four new sub-faces are created on the finer k+1 level (step 440). Each of the sub-faces is tested and subdivided if required (step 450). Otherwise, no further subdivision of the given face is performed (step 460). Subdivision is performed up to a maximum of maxₗₑᵥₑₗ levels.

Reference is now made to FIG. 5, which is a simplified flowchart of an exemplary main oracle function. The main oracle function of FIG. 5 determines if a selected face will be subdivided. Other main oracle functions may be defined, based on different criteria or information.

The exemplary main oracle function of FIG. 5 takes into account the following properties of the face:
Visibility—the face is subdivided only if at least one normal is pointing toward the viewer.
Curvature of the surface patch (as determined by the deviation of the normals within the face, and possibly the normals of the immediate neighbors)—high curvature faces are subdivided.
Silhouette proximity—the subdivision depth is increased if there is a normal that forms an angle close to π/2 with the viewing direction.
Feature edges and vertices within the face—the face is subdivided if there is a special feature present within the face.

Thus, the main oracle function ensures that the subdivision is applied only where it is required and up to the correct depth.

Detailed descriptions of different oracle functions may be found in Lai and Cheng, 2005, Müller and Havemann, 2000, Settgast et al., 2004, and Wu and Peters, 2005, which are incorporated fully herein by reference.

A preferred embodiment of a data structure for performing adaptive tessellation is now described.

Denote the maximal subdivision level for the scene as maxₗₑᵥₑₗ and the maximal vertex valence by valₘₐₓ. In the preferred embodiment, the static data structure includes the following arrays for each level k=0, . . . , maxₗₑᵥₑₗ:
1. One two-dimensional array of the size (2^{k}+3)×(2^{k}+3) for positions of the control vertices;
2. One two-dimensional array of the size 2^{k}×2^{k} for the pseudo-faces.
3. Four one-dimensional neighboring vertex arrays for the positions of the immediate neighbor vertices of the corner vertices.
4. Four one-dimensional opposing vertex arrays for the positions of the “opposite” vertices in the neighboring faces of the corner vertices.

In order to perform a single subdivision step for a face, the face vertices and the vertices of the neighboring faces are averaged as described above. The level-zero tables are initialized with the positions of the initial control mesh vertices.

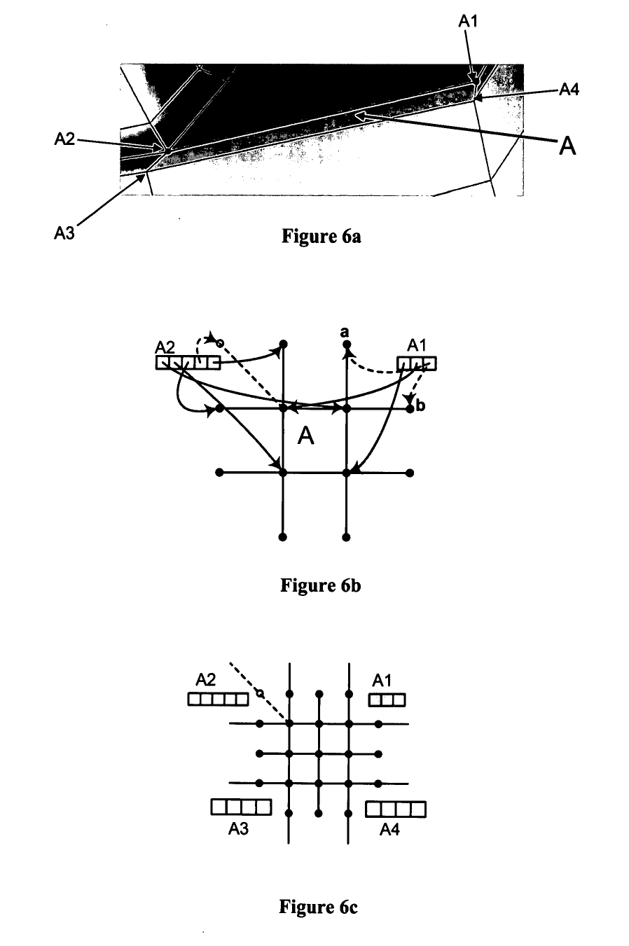

Reference is now made to FIGS. 6a-6c which illustrate an example of the initialization of the level-zero and level-one data structures for the illustrated face of the base mesh. FIG. 6a shows a face A of an exemplary control mesh structure. The relationship of face A to the surrounding structure determines the valences of each of the corner vertices of face A, and consequently of the required the level-zero data structure. Corner vertices A1 and A2 have non-regular valences (of three and five respectively), while corner vertices A3 and A4 both have regular valences of four.

FIG. 6b illustrates the required structure of the level-zero table face A. The position of each of the corner vertices A1-A4 and their immediate neighbors are stored in a two-dimensional array of size 16×16, that is of size (2^{k}+3)×(2^{k}+3) with k equal to zero. Additionally, a one-dimensional neighboring vertex array is initialized for each corner vertex. The size of each of the neighboring vertex arrays equals the valence of the respective corner vertex. Thus the array for corner vertex A1 is of size three, whereas the array for corner vertex A2 is of size five. The neighboring vertex arrays are initialized with the positions of the immediate neighbor vertices for the respective corner. (Note that positions a and b shown in the control mesh are actually a single location, as illustrated by their having a single value in the data array of the corner vertex.) Likewise the opposing vertex arrays are initialized with the positions of the opposing vertices that share a face with the respective corner vertex, but not an edge.

The positions of the control mesh vertices resulting from the first level of subdivision are stored in the level-one data array. FIG. 6c shows the corner vertices of the level-one control mesh and of their immediate neighbor vertices (outside face A), which requires a correspondingly larger data array for level-one.

Additionally, the data structure includes pseudo-face tables, which are used for choosing subdivision rules and tesselation. Boundaries, sharp or semi-sharp features and so forth may be computed using special subdivision masks. Knowledge of which faces were subdivided on each level is required in order to render the resulting surface.

A face is defined as active if it is initialized and its control points have been computed and stored in the corresponding data array. Each active face (or sub-face) is tested by the main oracle function. If the main oracle function returns a positive answer, the face is subdivided and four new faces on the next level are activated (i.e. the positions of their vertices are written into the tables and the new faces are marked as active).

In this manner, the main oracle function regulates the subdivision level in the appropriate places. The main oracle function preferably ensures that only visible faces with either high curvature or containing some special features are subdivided. The faces in silhouette proximity may be considered valid for subdivision with a lower curvature threshold.

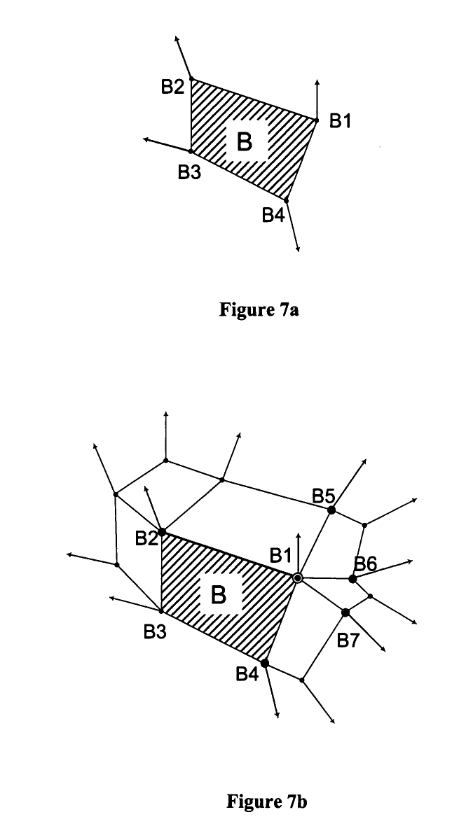

FIGS. 7a and 7b show an example of the input data for the main and edge oracles respectively, for the illustrated face B of a second exemplary control mesh structure. FIG. 7a shows the positions and the normal vectors of the face B's four vertices B1-B4, which may serve as the input for the main oracle function. FIG. 7b shows the data which may be used by the edge oracle function described below. For example, vertex B1 is of valence five, with immediate neighbor vertices {B2, B3, B5, B6, B7}. The normals and positions of vertices {B2, B3, B5, B6, B7} are passed as an input to the edge oracle function, and are used to compute the surface curvature at the vertex B1.

In addition to the main oracle function, an edge oracle function is preferably used to determine the subdivision depth on the edges of the coarse faces of the base mesh. The computation of the edge subdivision depths may be performed at a preprocessing stage, and stays valid as long as the base mesh does not change.

The reason for incurring the overhead of calculating the subdivision depth along the edges of the input mesh, however small it may be, is that we need to seamlessly render all the faces of the mesh as one surface. The edge subdivision depths are preferably calculated for the complete base mesh prior to the subdivision process. The calculated edge subdivision depths then serve as constraints when subdividing the faces adjacent to the base mesh edges, thus ensuring that edges shared by adjacent coarse faces may be tessellated to form a smooth limit surface.

In the preferred embodiment, the edge oracle function uses similar reasoning to the main oracle function. The difference is that input to the edge oracle function includes the positions and normals of the edge vertices and their immediate neighbors on the coarse initial mesh (see FIG. 7b).

In order to ensure consistency, edges that share a vertex preferably do not have drastically different subdivision depths. Consistency may be ensured based on the information regarding the common shared vertex, which is passed as input to the edge oracle function. The edge oracle function preferably works as follows. First the subdivision depths of each edge, d₀ and d₁, are evaluated separately using the positions and the normal vectors of the neighbors of the corresponding edge vertex. The final edge subdivision depth is computed by averaging these two values (i.e. d₀ and d₁). A more flexible adaptive subdivision may be performed by setting a varying subdivision depth along the edge, for example by gradually changing the subdivision depth from d₀ to dï.

For proper rendering, the edge and the main oracle functions should return consistent results, therefore the two functions preferably do not differ significantly and use the same reasoning.

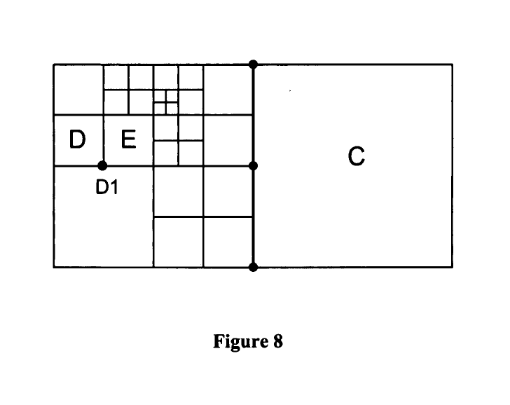

Preferably, a further constraint for the main oracle function is that the subdivision depth between the adjacent faces changes gradually and/or is limited to a specified difference. For example, it may be required that the maximal difference between the two adjacent faces inside the initial base mesh face be equal to one, and that the difference between the subdivision depth of the face adjacent to the initial edge and the pre-computed subdivision depth of that edge should not exceed one. FIG. 8 illustrates a subdivided mesh in which these constraints are upheld.

Preferably, the computed subdivision surface is rendered. When rendering the surface it is desired to provide a visually smooth surface as an output, except for the predefined creases. The above constraints enable us to define a simple tessellation strategy that provides a valid mesh for the adaptively subdivided surface with no T-junctions, and hence no rendering artifacts such as gaps between the faces.

All faces are projected to the limit surface for rendering with the real limit normals, to ensure that the positions of the vertices on the edges between differently subdivided quads do not differ. Moreover, the input to the main and/or edge oracle functions preferably includes the limit surface positions and normals, in order to produce accurate results. The evaluation of the limit surface on the coarse levels may be reused for the even control points of the finer levels.

While rendering quads of an adaptively subdivided mesh, gaps may occur between adjacent faces on different subdivision levels (as would occur for the T-junction topology of the exemplary mesh illustrated FIG. 8). In order to eliminate these gaps, the subdivided mesh is preferably tessellated to create a version which does not include any T-junctions. Tessellation methods typically require information about the subdivision depths of the neighboring faces. For sub-faces within a coarse face, this information is readily available from the pseudo-face tables.

In the preferred embodiment, faces that are adjacent to the initial mesh edges are tessellated using the pre-computed results of the corresponding edge oracle function. Recall that the difference between the subdivision depths of the adjacent faces preferably does not exceed one level. This constraint is appropriate for rendering a smooth surface, with continuous curvature everywhere except for the creases. The same is true for the difference between the subdivision depth of the face adjacent to the initial base mesh edge and the pre-computed subdivision depth of the base mesh edge.

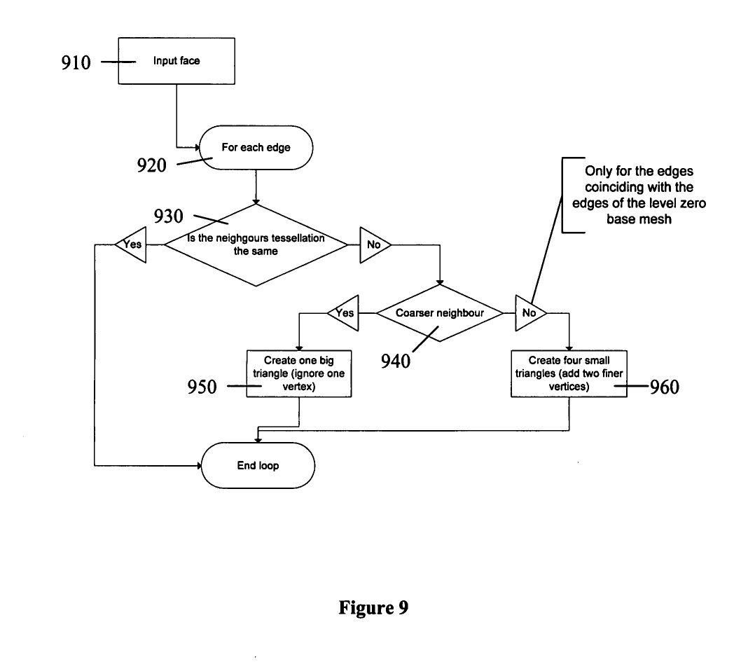

Reference is now made to FIG. 9, which is a simplified flowchart of a method for tessellating a quad mesh, according to a preferred embodiment of the present invention. In step 910 the data for a selected face is provided. The following process is performed for each edge (step 920). In step 930, the neighboring faces are checked to determine if the tessellation is the same. If yes, the method ends (and is then performed as necessary for other faces of the mesh). If the tessellation differs, a further check is made in step 940 to determine if the neighbor is of coarser tessellation than the current face. If neighbor is coarser, one of the vertices of the face is ignored, creating a large triangular face adjacent to the corresponding edge. If the neighbor is more finely tessellated, two finer vertices are added to the face, creating four small triangles adjacent to the corresponding edge.

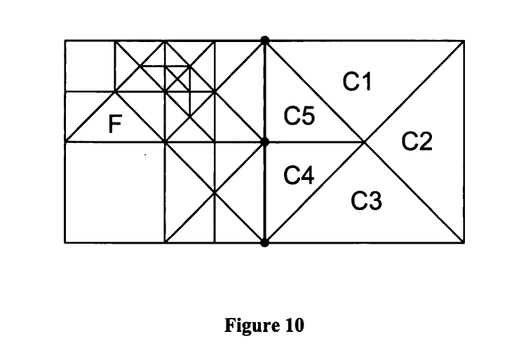

FIG. 10 illustrates a tessellated version of the mesh of FIG. 8 which was obtained by application of the above method, and which does not include T-junctions. Vertex D1 of FIG. 8 has been ignored, thus forming triangular face F, and face C of FIG. 8 has been subdivided into triangular faces C1-C5.

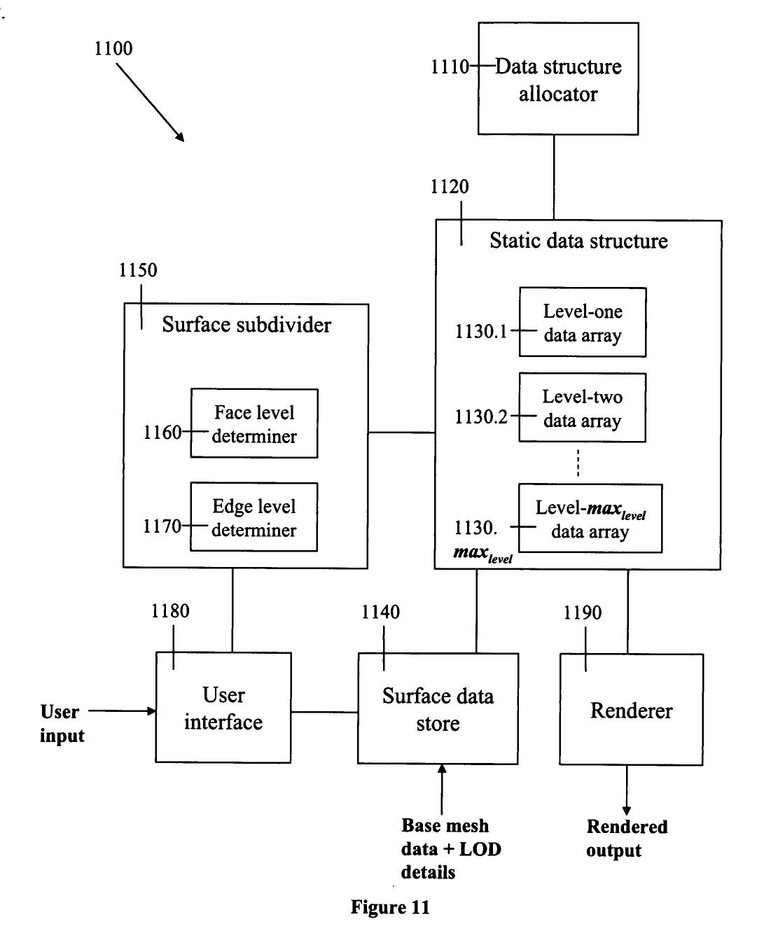

Reference is now made to FIG. 11, which is a simplified block diagram of an apparatus for the computation of a subdivision surface, according to a preferred embodiment of the present invention. Apparatus 1100 includes data structure allocator 1110 and surface subdivider 1150. Data structure allocator 1110 allocates the static data structure 1120. As described above, static data structure 1120 includes a respective data array 1130.k for each subdivision level k=1, . . . , maxₗₑᵥₑₗ, wherein a size of each of the data arrays is determined in accordance with the respective subdivision level k. Base mesh data and LOD modifications are stored in surface data store 1140. Static data structure 1120 is preferably allocated prior to beginning the subdivision process, based on a specified maximum number of subdivision levels, maxₗₑᵥₑₗ. Surface subdivider 1150 recursively subdivides the base mesh faces, and stores the data for each level x of the subdivision process in the respective data array 1130.x.

The structure of static data structure is determined by the information required for the subdivision algorithm implemented by surface subdivider 1150. In the exemplary embodiment presented above (based on the Catmull-Clark subdivision scheme), static data structure 1120 includes for each subdivision level:
1. A data array of the size (2^{k}+3)×(2^{k}+3) for positions of the control vertices;
2. A pseudo-face data table of the size 2^{k}×2^{k} for tags.
3. Four one-dimensional neighboring vertex arrays
4. Four one-dimensional opposing vertex arrays

Surface subdivider 1150 preferably includes face level determiner 1160, which corresponds to the above-described main oracle, and/or edge level determiner 1170, which corresponds to the above-described edge oracle. Face level determiner 1160 and edge level determiner 1170 together determine whether a further level of subdivision will be performed on a given face or sub-face.

Apparatus 1100 preferably includes user interface 1180 which receives external control information from the user. User interface 1180 enables interactive user control of each stage of the subdivision process. For example, after each subdivision level the user may modify control mesh data, introduce local features, or define the direction of view. User interface 1180 may also serve for inputting the base mesh data.

In the preferred embodiment, apparatus 1100 includes renderer 1190 which tessellates the subdivided surface, and renders the surface for display.

In a further preferred embodiment, a computer-readable storage medium contains a set of instructions for computing a subdivision surface. The set of instructions includes a data structure allocation routine, a base mesh initialization routine, and a subdivision routine. The data structure allocation routine creates a static data structure which includes a respective data array for each subdivision level, wherein a size of each of the data arrays is determined by the respective subdivision level. The base mesh initialization routine stores base mesh data in a level-zero data array. The subdivision routine recursively subdivides faces defined by the base mesh data, wherein data for each subdivision level is stored in the respective data array.

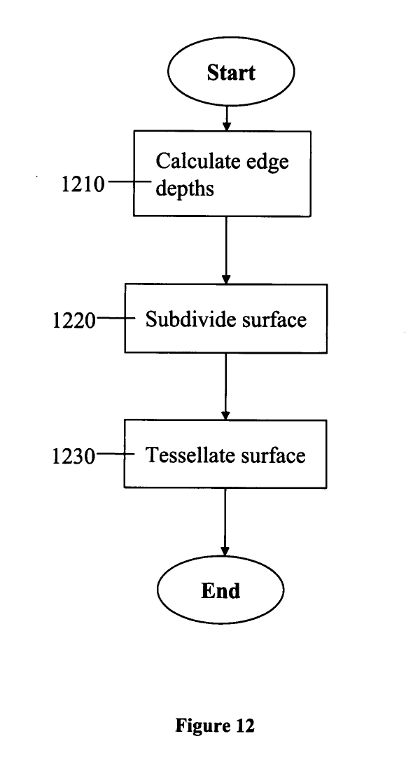

Reference is now made to FIG. 12, which is a simplified block diagram of a method for rendering a subdivision surface derived from a base mesh of coarse faces, according to a preferred embodiment of the present invention. In step 1210 a respective edge subdivision depth is calculated for each edge of the coarse faces. These depths serve as hard constraints during the subdivision process 1220. In step 1230, the subdivision surface is tessellated in accordance with the calculated subdivision depths, in order to eliminate T-junctions along the edges. A subdivision surface patch is described by the data stored in a data structure comprising a hierarchy of data arrays, as described above.

It is expected that during the life of this patent many relevant surface representation models, subdivision methods, rendering techniques and graphics processing elements will be developed and the scope of the corresponding terms is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following example, which together with the above descriptions, illustrate the invention in a non-limiting fashion.

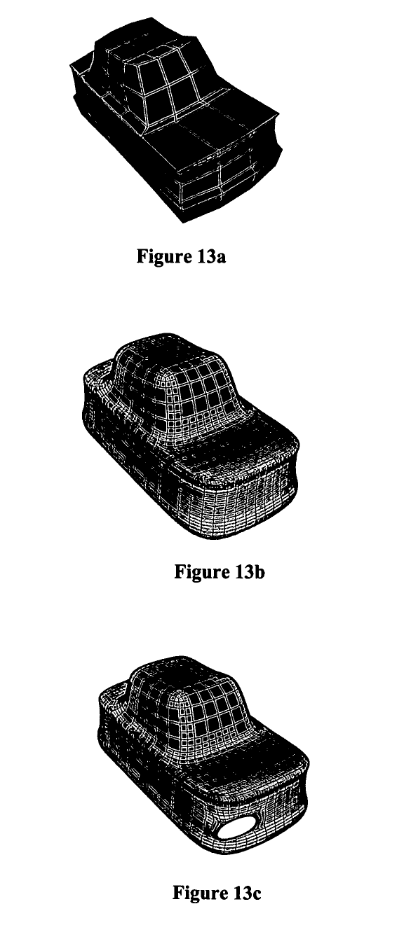

FIG. 13a shows a base mesh. The base mesh is adaptively subdivided and tessellated according to the above-described embodiments, to form the subdivided surface shown in FIG. 13b. FIG. 13c shows the same model with modified topology, which is obtained by deleting one of the faces of the base mesh.

The fully subdivided version of the mesh of FIG. 13a consists of approximately 150,000 quads (i.e. a mesh obtained by a uniform subdivision of all faces, such as the Catmull-Clark algorithm), while the adaptively subdivided version of FIG. 13b comprises fewer than 4,000 polygons (the exact number depends on the viewing direction). The resulting smaller number of faces leads to a reduced amount of computations and faster rendering. The dramatic reduction of the size of the finally rendered mesh is a consequence of the full flexibility of the above-described embodiments. The faces on each level are not subdivided uniformly, but only where subdivision is required.

In conclusion, the above-described embodiments produce high-quality rendering of three-dimensional scenes without any dynamic allocations. The subdivision scheme supports LOD modeling with interactive input from the artist, as well as the adaptive tessellation of regions which contain features on non-zero subdivision levels. A Graphics Processing Unit (GPU) may be used for the computations, since every face is processed separately from the rest of the faces.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

### LIST OF RELEVANT REFERENCES

H. BIERMANN, A. LEVIN, AND D. ZORIN, Piecewise smooth subdivision surfaces with normal control, in Proc. of SIGGRAPH'00, 2000, pp. 113-120.
J. BOLZ AND P. SCHRÖDER, Rapid evaluation of Catmull/Clark subdivision surfaces, in Proc. of Web3D'02 Symposium, February 2002, pp. 11-17.
J. BOLZ AND P. SCHRÖDER, Evaluation of subdivision surfaces on programmable graphics hardware, multires.caltech.edu/pubs/GPUSubD.pdf.
E. CATMULL AND J. CLARK, Recursively generated b-spline surfaces on arbitrary topological meshes, Computer Aided Design, (1978), pp. 350-355.
T. DEROSE, M. KASS, AND T. TRUONG, Subdivision surfaces in character animation, in Proc. of ACM SIGGRAPH'98, Annual Conference Series, ACM, 1998, pp. 85-94.
S. HAVEMANN, Interactive rendering of Catmull/Clark surfaces with crease edges, The Visual Computer, 18 (2002), pp. 286-298.
S. LAI AND F. F. CHENG, Adaptive rendering of Catmull/Clark subdivision surfaces, in Proc. of Computer Aided Design and Computer Graphics, December 2005, pp. 125-132.
K. MÜLLER AND S. HAVEMANN, Subdivision surface tessellation on the fly using a versatile mesh data structure, Computer Graphics Forum, 19(3) (2000), pp. 151-159.
U. REIF, A unified approach to subdivision algorithms near extraordinary vertices, Computer Aided Geometric Design, 12 (1995), pp. 153-174.
T. SEDERBERG, D. L. CARDON, G. T. FINNIGAN, J. ZHENG, AND T. LYCHE, T-spline simplification and local refinement, ACM Transactions on Graphics (Proceedings of SIGGRAPH 2004), 23 (2004), pp. 276-283.
V. SETTGAST, K. MULLER, C. FUNFZIG, AND D. W. FELLNER, Adaptive tessellation of subdivision surfaces, Computers & Graphics, (2004), pp. 73-78.
L.-J. SHIUE, I. JONES, AND J. PETERS, A realtime GPU kernel, ACM Transactions on Graphics pp. 1010-1015, 2005.
J. STAM, Exact evaluation of Catmull-Clark subdivision surfaces at arbitrary parameter values, in Proc. of SIGGRAPH' 98, 1998, pp. 395-404.
VALVE CORPORATION, Half-life 2, Web Resource. http://half-life2.com/, 2004.
X. WU AND J. PETERS, An accurate error measure for adaptive subdivision surfaces, in Proc. of Shape Modeling and Applications, June 2005, pp. 51-56.
D. ZORIN AND P. SCHRÖDER, Subdivision for Modeling and Animation, SIGGRAPH 2000 Course Notes, 2000.

What is claimed is:

1. A method for the computation of a subdivision surface from a base mesh of coarse faces, said computation being performed over a plurality of successive subdivision levels, each of said subdivision levels providing a finer mesh of faces, wherein said computation is performed up to a specified maximum of levels, comprising:
allocating memory for a static data structure comprising a hierarchy of data arrays, wherein each of said data arrays is for storing control mesh data for a single coarse face at a respective subdivision level, and wherein a size of each of said data arrays is determined by said respective subdivision level;
subdividing a coarse face defined by said base mesh; and
storing data resulting from each subdivision level in said respective data array.

2. A method according to claim 1, further comprising performing said computation adaptively, by, at each subdivision level prior to said specified maximum of levels, separately determining whether to perform a further level of subdivision for each sub-face at said subdivision level.

3. A method according to claim 1, wherein said subdividing is performed sequentially for each of said coarse faces.

4. A method according to claim 1, wherein said subdividing is performed recursively.

5. A method according to claim 1, wherein said subdivision surface comprises a mesh of polygons.

6. A method according to claim 1, wherein said subdividing a face comprises:
determining whether a further level of subdivision of said face is required; and
if a further level is required, subdividing said face into a plurality of sub-faces.

7. A method according to claim 6, further comprising providing said plurality of sub-faces as input for a subsequent level of subdividing.

8. A method according to claim 2, wherein said determining is performed in accordance with at least one of a group of characteristics of said face, said group comprising: visibility, projected size, presence of special features, silhouette, and curvature.

9. A method according to claim 1, wherein said data arrays are for storing two-dimensional data.

10. A method according to claim 1, wherein, for a subdivision level, said data stored in said respective data array comprises a respective position of all vertices of the sub-faces of said coarse face at said subdivision level, and a respective position of all vertices comprising immediate neighbors of said vertices of the sub-faces of said coarse face at said subdivision level.

11. A method according to claim 1, wherein a size of said respective data array for a specified subdivision level comprises a minimal size for storing coordinates for a fully-divided coarse face at said specified subdivision level.

12. A method according to claim 1, wherein a size of said respective data array for a specified subdivision level comprises (2k+3)², wherein k equals said specified subdivision level.

13. A method according to claim 1, wherein said static data structure further comprises a respective pseudo-face data array for each of said subdivision levels, said pseudo-face data array being for storing a respective tag for controlling a subsequent level of subdividing, for each sub-face of said coarse face.

14. A method according to claim 1, wherein said static data structure further comprises a respective neighboring vertex array for each corner vertex of said coarse face, a neighboring vertex array being for storing positions of immediate neighbor vertices of said respective corner vertex.

15. A method according to claim 1, wherein said static data structure further comprises a respective opposing vertex array for each corner vertex of said coarse face, an opposing vertex array being for storing positions of opposing vertices of neighboring faces of said respective corner vertex.

16. A method according to claim 1, further comprising calculating a respective edge subdivision depth for each edge of said coarse faces of said base mesh, wherein said edge subdivision depths are for controlling said subdividing.

17. A method according to claim 16, further comprising ensuring that a difference in subdivision depths of adjacent coarse faces of said subdivided surface is bounded to a specified maximum difference.

18. A method according to claim 1, further comprising preprocessing an original mesh for subdivision to form a base mesh appropriate for said subdividing.

19. A method according to claim 1, further comprising tessellating said subdivided surface.

20. A method according to claim 19, wherein said tessellating comprises removing T-junctions from said subdivided surface.

21. A method according to claim 19, wherein tessellating an edge shared by adjacent coarse faces of said base mesh is performed in accordance with edge subdivision depths calculated respectively for each of said adjacent coarse faces.

22. A method according to claim 19, wherein tessellating an edge shared by adjacent sub-faces within a coarse face is performed in accordance with tags stored in a pseudo-face data array.

23. A method according to claim 1, further comprising rendering said subdivided surface for display.

24. A method according to claim 1, wherein said subdividing comprises:
for each of said faces, calculating a face control point as an average of the corner of vertices of said face; and
initializing a respective data array of a subsequent level of subdivision with said computed face control points.

25. A method according to claim 24, wherein said subdividing further comprises:
calculating even control points for said subsequent level of subdivision from even control points of a current level of subdivision, edge control points of said current level of subdivision and face control points of said subsequent level of subdivision;
calculating edge control points as an average of the edge endpoints of said faces and of said computed face control points for faces adjacent to said face; and
further initializing said respective data array of said subsequent level of subdivision with said computed edge control points and said computed even control points.

26. An apparatus for the computation of a subdivision surface from a base mesh of coarse faces, said computation being performed over a plurality of successive subdivision levels, each of said subdivision levels providing a finer mesh of faces, wherein said computation is performed up to a specified maximum of levels, comprising:
a data structure allocator, configured for allocating a static data structure comprising a hierarchy of data arrays, wherein each of said data arrays is for storing control mesh data for a single coarse face at a respective subdivision level, and wherein a size of each of said data arrays is determined by said respective subdivision level; and
a surface subdivider associated with said static data structure, configured for subdividing a coarse face defined by said base mesh, and for storing data resulting from each subdivision level in said respective data array.

27. An apparatus according to claim 26, wherein said surface subdivider is operable to perform said computation adaptively by, at each subdivision level prior to said specified maximum of levels, separately determining whether to perform a further level of subdivision for each sub-face at said subdivision level.

28. An apparatus according to claim 26, wherein said data structure allocator is operable to allocate said static data structure prior to the performance of said subdividing.

29. An apparatus according to claim 26, wherein said surface subdivider is further configured to ensure that a subdivision level is within said specified maximum of levels.

30. An apparatus according to claim 26, wherein said surface subdivider is further configured to subdivide each coarse face of said base mesh separately from other coarse faces of said base mesh.

31. An apparatus according to claim 26, wherein, for a subdivision level, said data stored in said respective data array comprises a respective position of all vertices of the sub-faces of said coarse face at said subdivision level, and a respective position of all vertices comprising immediate neighbors of said vertices of the sub-faces of said coarse face at said subdivision level.

32. An apparatus according to claim 26, wherein a size of said respective data array for a specified subdivision level comprises (2k+3)², wherein k equals said specified subdivision level.

33. An apparatus according to claim 26, wherein said static data structure further comprises a respective pseudo-face data array for each of said subdivision levels, said pseudo-face data array being for storing a respective tag for controlling a subsequent level of subdividing, for each sub-face of said coarse face.

34. An apparatus according to claim 26, wherein said static data structure further comprises a respective neighboring vertex array for each corner vertex of said coarse face, a neighboring vertex array being for storing positions of immediate neighbor vertices of said respective corner vertex.

35. An apparatus according to claim 26, wherein said static data structure further comprises a respective opposing vertex array for each corner vertex of said coarse face, an opposing vertex array being for storing positions of opposing vertices of neighboring faces of said respective corner vertex.

36. An apparatus according to claim 26, wherein said surface subdivider comprises a face level determiner configured for determining whether a further level of subdivision of said face is required.

37. An apparatus according to claim 26, wherein said surface subdivider comprises an edge level determiner configured for calculating a respective subdivision depth for each edge of said coarse faces of said base mesh, wherein said edge subdivision depths are for controlling said subdividing.

38. An apparatus according to claim 35, wherein said surface subdivider is configured for ensuring that a difference in subdivision depths of adjacent faces of said subdivided surface is bounded to a specified maximum difference.

39. An apparatus according to claim 26, further comprising a preprocessor configured for preprocessing an original mesh for subdivision to form a base mesh appropriate for said subdividing.

40. An apparatus according to claim 26, further comprising a renderer configured for tessellating said subdivided surface.

41. An apparatus according to claim 40, wherein tessellating comprises removing T-junctions from said subdivided surface.

42. An apparatus according to claim 40, wherein said renderer is further configured for rendering said subdivided surface for display.

43. An apparatus according to claim 26, further comprising a user interface configured for interactively obtaining user control information during said subdividing.

44. A computer-readable storage medium containing a set of instructions for a method for calculating a subdivision surface from a base mesh of coarse faces, the set of instructions comprising:
a data structure allocation routine, allocating memory for a static data structure comprising a hierarchy of data arrays, wherein each of said data arrays is for storing control mesh data for a single coarse face at a respective subdivision level, and wherein a size of each of said data arrays is determined by said respective subdivision level; and
a subdivision routine, for subdividing a coarse face defined by said base mesh, and storing data resulting from each subdivision level in said respective data array.

45. A method for rendering a subdivision surface derived from a base mesh of coarse faces, comprising:
calculating a respective edge subdivision depth for each edge of said coarse faces; and
tessellating a subdivision surface defined in a data structure comprising a hierarchy of data arrays, wherein each of said data arrays is for storing control mesh data for a coarse face at a respective subdivision level, in accordance with said calculated subdivision depths so as to eliminate T-junctions along said edges.
